(19) United States
(12) Patent Application Publication
(10) Pub. No.: US 2008/0051535 A1
(43) Pub. Date: Feb. 28, 2008

(54) Promoter system for polymerization processes and polymers formed therefrom

(75) Inventors: Kayo Vizzini, Pasadena, TX (US); Steven Gray, Bellaire, TX (US)

Correspondence Address: FINA TECHNOLOGY INC, PO BOX 674412, HOUSTON, TX, 77267-4412, US

(73) Assignee: Fina Technology, Inc., Houston, TX (US)

(21) Appl. No.: 11/508,772

(22) Filed: Aug. 23, 2006

(51) Int. Cl. C08F 4/44

(52) U.S. Cl. 526/124.3

(57) ABSTRACT

Polymerization processes and polymers formed therefrom are described herein. Such processes generally include providing a catalyst system, introducing the catalyst system to a reaction zone, introducing 1-chlorobutane to the reaction zone, introducing an olefin monomer to the reaction zone, contacting the olefin monomer with the catalyst system in the presence of the 1-chlorobutane to form a polyolefin and withdrawing the polyolefin from the reaction zone. The catalyst system is generally formed from a process including contacting a magnesium dialkoxide compound with a first agent to form a first compound, contacting the first compound with a plurality of halogenating/titanating agents to form a reaction product and contacting the reaction product with an activating agent to form the catalyst system.

### FIELD

Embodiments of the present invention generally relate to polymerization processes. In particular, embodiments relate to promoters for polymerization processes.

### BACKGROUND

While broad molecular weight polymers provide processing advantages, such broad molecular polymers have generally not been utilized in barrier film applications due to their tendency towards permeation, especially in thin film applications.

Therefore, a need exists to form polymers exhibiting advantages of broad molecular weight polymers with enhanced barrier properties.

### SUMMARY

Embodiments of the present invention include polymerization processes. Such processes generally include providing a catalyst system, introducing the catalyst system to a reaction zone, introducing 1-chlorobutane to the reaction zone, introducing an olefin monomer to the reaction zone, contacting the olefin monomer with the catalyst system in the presence of the 1-chlorobutane to form a polyolefin and withdrawing the polyolefin from the reaction zone. The catalyst system is generally formed from a process including contacting a magnesium dialkoxide compound with a first agent to form a first compound, contacting the first compound with a plurality of halogenating/titanating agents to form a reaction product and contacting the reaction product with an activating agent to form the catalyst system.

Embodiments of the invention further include a polymer produced from the process described above.

In one or more embodiments, the polymer includes polyethylene.

Embodiments of the invention further include polymerization processes wherein the catalyst system is formed by contacting butyl ethyl magnesium with a first agent represented by the formula ClA(OR⁴)_{y} to form a first compound, wherein Cl is chlorine, A is selected from titanium, silicon, aluminum, carbon, tin and germanium, R⁴ is selected from C₁ to C₁₀ alkyls, x is 0 or 1 and y is the valence of A minus 1, contacting the first compound with a second agent represented by the formula TiC₄/Ti(OR⁵)₄, wherein R⁵ is selected from C₂ to C₁₀ alkyl groups, contacting the first compound with a plurality of halogenating/titanating agents to form a reaction product, wherein at least one of the plurality of halogenating/titanating agents is TiCl₄ and contacting the reaction product with an activating agent including an organoaluminum compound to form the catalyst system.

### BRIEF DESCRIPTION OF DRAWINGS

FIG. 1 illustrates a graphical representation of activity relative to promoter concentration.

FIG. 2 illustrates a graphical representation of polymer melt index relative to promoter concentration.

FIG. 3 illustrates a graphical representation of shear response relative to promoter concentration.

FIG. 4 illustrates a graphical representation of GPC data.

### DETAILED DESCRIPTION

### Introduction and Definitions

A detailed description will now be provided. Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims. Each of the inventions will now be described in greater detail below, including specific embodiments, versions and examples, but the inventions are not limited to these embodiments, versions or examples, which are included to enable a person having ordinary skill in the art to make and use the inventions when the information in this patent is combined with available information and technology.

Various terms as used herein are shown below. To the extent a term used in a claim is not defined below, it should be given the broadest definition persons in the pertinent art have given that term as reflected in printed publications and issued patents. Further, unless otherwise specified, all compounds described herein may be substituted or unsubstituted and the listing of compounds includes derivatives thereof.

The term “activity” refers to the weight of product produced per weight of the catalyst used in a process per hour of reaction at a standard set of conditions (e.g., grams product/gram catalyst/hr).

The term “substituted” refers to an atom, radical or group replacing hydrogen in a chemical compound.

The term “blend” refers to a mixture of compounds that are blended and/or mixed prior to contact with another compound.

As used herein, “polymer density” is measured via ASTM-D-1238.

As used herein, “meltflow index” is measured via ASTM-D-1238-E.

The term “equivalent” refers to a molar ratio of two components.

As used herein, “room temperature” means that a temperature difference of a few degrees does not matter to the phenomenon under investigation, such as a preparation method. In some environments, room temperature may include a temperature of from about 20° C. to about 28° C. (68° F. to 82° F.), while in other environments, room temperature may include a temperature of from about 50° F. to about 90° F., for example. However, room temperature measurements generally do not include close monitoring of the temperature of the process and therefore such a recitation does not intend to bind the embodiments described herein to any predetermined temperature range.

As used herein, “sheer thinning” is gauged by a polymer's high and low melt flow ratios (e.g., HLMI/MI₅ is referred to as SR₅ and HLMI/MI₂ is referred to as SR₂).

### Catalyst Systems

Ziegler-Natta catalyst systems are generally formed from the combination of a metal component (e.g., a catalyst precursor) with one or more additional components, such as a catalyst support, a cocatalyst and/or one or more electron donors, for example.

A specific example of a Ziegler-Natta catalyst includes a metal component generally represented by the formula:

MR^{A}ₓ;

wherein M is a transition metal, R^{A} is a halogen, an alkoxy or a hydrocarboxyl group and x is the valence of the transition metal. For example, x may be from 1 to 4.

The transition metal may be selected from Groups IV through VIB (e.g., titanium, vanadium or chromium), for example. R^{A} may be selected from chlorine, bromine, carbonates, esters, or alkoxy groups in one embodiment. Examples of catalyst components include TiCl₄, TiBr₄, Ti(OC₂H₅)₃Cl, Ti(OC₃H₇)₂Cl₂, Ti(OC₆H₁₃)₂Cl₂, Ti(OC₂H₅)₂Br₂ and Ti(OC₁₂H₂₅)Cl₃, for example.

Those skilled in the art will recognize that a catalyst may be “activated” in some way before it is useful for promoting polymerization. As discussed further below, activation may be accomplished by contacting the catalyst with an activator “Z-N activator”, which is also referred to in some instances as a “cocatalyst.” Embodiments of such Z-N activators include organoaluminum compounds, such as trimethyl aluminum (TMA), triethyl aluminum (TEAl) and triisobutyl aluminum (TIBAl), for example.

The Ziegler-Natta catalyst system may further include one or more electron donors, such as internal electron donors and/or external electron donors. Internal electron donors may be used to reduce the atactic form of the resulting polymer, thus decreasing the amount of xylene solubles in the polymer. The internal electron donors may include amines, amides, esters, ketones, nitrites, ethers, phosphines, diethers, succinates, phthalates, or dialkoxybenzenes, for example. (See, U.S. Pat. No. 5,945,366 and U.S. Pat. No. 6,399,837, which are incorporated by reference herein.)

External electron donors may be used to further control the amount of atactic polymer produced. The external electron donors may include monofunctional or polyfunctional carboxylic acids, carboxylic anhydrides, carboxylic esters, ketones, ethers, alcohols, lactones, organophosphorus compounds and/or organosilicon compounds. In one embodiment, the external donor may include diphenyldimethoxysilane (DPMS), cyclohexymethyldimethoxysilane (CDMS), diisopropyldimethoxysilane and/or dicyclopentyldimethoxysilane (CPDS), for example. The external donor may be the same or different from the internal electron donor used.

The components of the Ziegler-Natta catalyst system (e.g., catalyst, activator and/or electron donors) may or may not be associated with a support, either in combination with each other or separate from one another. The Z-N support materials may include a magnesium dihalide, such as magnesium dichloride or magnesium dibromide, or silica, for example.

Embodiments of the invention include catalyst processes as described below. (See, U.S. Pat. No. 6,734,134 and U.S. Pat. No. 6,174,971, which are incorporated by reference herein.)

A representative, non-limiting, illustration of a possible reaction scheme may be illustrated as follows (wherein products within parentheses refer to reaction products rather than a component of a compound, such as “A” vs. A):

### 1) MgR¹R²+2R³OH->Mg(OR³)₂+R¹H+R²H

### 2) Mg(OR³)₂+ClA(OR⁴)_{y}->“A”

### 3) “A”+TiCl₄(OR⁵)₄->“B”

### 4) “B”+TiCl₄->“C”

### 5) “C”+TiCl₄->“D”

### 6) “D”+AR⁶₃>Catalyst

Note that while the primary reaction components are illustrated above, additional components may be reaction products or used in such reactions and not illustrated above. Further, while described herein in terms of primary reaction steps, it is known to those skilled in the art that additional steps may be included in the reaction schemes and processes described herein (e.g., washing, filtering, drying or decanting steps), while it is also further contemplated that other steps may be eliminated in certain embodiments. In addition, it is contemplated that any of the agents described herein may be added in combination with one another so long as the order of addition complies with the spirit of the invention. For example, the third and fourth agents may be added to reaction product B at the same time to form reaction product D. Further, particular catalyst and their preparation methods may include one or more of the steps described below and may further include additional steps known to one skilled in the art, such as supporting the catalyst, for example.

Such methods may include contacting an alkyl magnesium compound with an alcohol to form a magnesium dialkoxide compound. Such reaction may occur at a reaction temperature ranging from about −78° C. to about 102° C. or from room temperature to about 90° C. for a time of up to about 10 hours, for example.

The alcohol may be added to the alkyl magnesium compound in an equivalent of from about 0.5 to about 6 or from about 1 to about 3, for example.

The alkyl magnesium compound may be represented by the following formula:

MgR¹R²;

wherein Mg is magnesium, R¹ and R² are independently selected from C₁ to C₁₀ alkyl groups. Non-limiting illustrations of alkyl magnesium compounds include butyl ethyl magnesium (BEM), diethyl magnesium, dipropyl magnesium and dibutyl magnesium, for example.

The alcohol may be represented by the formula:

R³OH;

wherein R³ is selected from C₂ to C₂₀ alkyl groups. Non-limiting illustrations of alcohols (e.g., OH) generally include butanol, isobutanol and 2-ethylhexanol, for example.

The method may then include contacting the magnesium dialkoxide compound with a first agent to form reaction product “A”.

Such reaction may occur in the presence of an inert solvent. A variety of hydrocarbons can be used as the inert solvent, but any hydrocarbon selected should remain in liquid form at all relevant reaction temperatures and the ingredients used to form the supported catalyst composition should be at least partially soluble in the hydrocarbon. Accordingly, the hydrocarbon is considered to be a solvent herein, even though in certain embodiments the ingredients are only partially soluble in the hydrocarbon.

Suitable hydrocarbons include substituted and unsubstituted aliphatic hydrocarbons and substituted and unsubstituted aromatic hydrocarbons. For example, the inert solvent may include hexane, heptane, octane, decane, toluene, xylene, dichloromethane or combinations thereof, for example.

The reaction may further occur at a temperature of from about 0° C. to about 100° C. or from about 20° C. to about 90° C. for a time of from about 0.2 hours to about 24 hours or from about 1 hour to about 4 hours, for example.

Non-limiting examples of the first agent are generally represented by the following formula:

ClA(OR⁴)_{y};

wherein Cl is chlorine, A is selected from titanium, silicon, aluminum, carbon, tin and germanium, R⁴ is selected from C₁ to C₁₀ alkyls, such as methyl, ethyl, propyl and isopropyl, x is 0 or 1 and y is the valence of A minus 1. Non-limiting illustrations of first agents include chlorotitaniumtriisopropoxide (ClTi(OⁱPr)₃) and ClSi(Me)₃, for example.

As described previously, the components described herein may or may not be associated with a support material. Such support methods are generally known to one skilled in the art. However, in one specific embodiment, the method includes contacting reaction product “A” with a support material, such as magnesium dichloride, magnesium dibromide or silica, for example.

The method may then include contacting reaction product “A” with a second agent to form reaction product “B”.

Such reaction may occur in the presence of an inert solvent. The inert solvents may include any of those solvents previously discussed herein, for example.

The reaction may further occur at a temperature of from about 0° C. to about 100° C. or from about 20° C. to about 90° C. for a time of from about 0.2 hours to about 36 hours or from about 1 hour to about 4 hours, for example.

The second agent may be added to reaction product “A” in an equivalent of from about 0.5 to about 5, or from about 1 to about 4 or from about 1.5 to about 2.5, for example.

The second agent may be represented by the following formula:

TiC₄/Ti(OR⁵)₄;

wherein R⁵ is selected from alkyl groups, such as butyl. Non-limiting illustrations of second agents include blends of titanium chloride and titanium alkoxides, such as TiCl₄/Ti(OBu)₄. The blends may have a molar ratio of TiCl₄:Ti(OR⁵)₄ of from about 0.5 to about 6 or from about 2 to about 3, for example.

The method may then include contacting reaction product “B” with a third agent to form reaction product “C”.

Such reaction may occur in the presence of an inert solvent. The inert solvents may include any of those solvents previously discussed herein, for example.

The reaction may further occur at room temperature, for example.

The third agent may be added to the reaction product “B” in an equivalent of from about 0.1 to about 5, or from about 0.25 to about 4 or from about 0.45 to about 4.5, for example.

Non-limiting illustrations of third agents include metal halides, such as titanium tetrachloride (TiCl₄), for example. The third agent may be added in a equivalent of from about 0.1 to about 5, or from about 0.25 to about 4 or from about 0.45 to about 4.5, for example.

The method may further include contacting reaction product “C” with a fourth agent to form reaction product “D”.

Such reaction may occur in the presence of an inert solvent. The inert solvents may include any of those solvents previously discussed herein, for example.

The reaction may further occur at room temperature, for example.

The fourth agent may be added to the reaction product “C” in an equivalent of from about 0.1 to about 5, or from about 0.25 to about 4 or from about 0.45 to about 4.5, for example.

Non-limiting illustrations of fourth agents include metal halides, such as titanium chloride (TiCl₄), for example.

The method may then include contacting reaction product “D” with a fifth agent to form the catalyst component.

The fifth agent may be added to the reaction product “D” in an equivalent of from about 0.1 to about 2 or from 0.5 to about 1.2, for example.

Non-limiting illustrations of fifth agents include organoaluminum compounds. The organoaluminum compounds generally include aluminum alkyls having the following formula:

AlR⁶₃;

wherein R⁶ is a C₁ to C₁₀ alkyl compound. Non-limiting illustrations of the aluminum alkyl compounds generally include trimethyl alumimum (TMA), triisobutyl aluminum (TIBAl), triethyl aluminum (TEAl), n-octyl aluminum and n-hexyl aluminum, for example.

Upon formation, the catalyst may optionally be subjected to heat-treating. Such heat-treating generally includes heating the catalyst to a temperature of from about 40° C. to about 150° C., or from about 90° C. to about 125° C. or from about 40° C. to about 60° C., for example. Such heat treatment may occur for a time of from about 0.5 hours to about 24 hours or from about 1 hour to about 4 hours, for example.

### Polymerization Processes

As indicated elsewhere herein, catalyst systems are used to form polyolefin compositions. Once the catalyst system is prepared, as described above and/or as known to one skilled in the art, a variety of processes may be carried out using that composition. The equipment, process conditions, reactants, additives and other materials used in polymerization processes will vary in a given process, depending on the desired composition and properties of the polymer being formed. Such processes may include solution phase, gas phase, slurry phase, bulk phase, high pressure processes or combinations thereof, for example. (See, U.S. Pat. No. 5,525,678; U.S. Pat. No. 6,420,580; U.S. Pat. No. 6,380,328; U.S. Pat. No. 6,359,072; U.S. Pat. No. 6,346,586; U.S. Pat. No. 6,340,730; U.S. Pat. No. 6,339,134; U.S. Pat. No. 6,300,436; U.S. Pat. No. 6,274,684; U.S. Pat. No. 6,271,323; U.S. Pat. No. 6,248,845; U.S. Pat. No. 6,245,868; U.S. Pat. No. 6,245,705; U.S. Pat. No. 6,242,545; U.S. Pat. No. 6,211,105; U.S. Pat. No. 6,207,606; U.S. Pat. No. 6,180,735; U.S. Pat. No. 6,147,173 and U.S. Pat. No. 7,034,092 which are incorporated by reference herein.)

In certain embodiments, the processes described above generally include polymerizing olefin monomers to form polymers. The olefin monomers may include C₂ to C₃₀ olefin monomers, or C₂ to C₁₂ olefin monomers (e.g., ethylene, propylene, butene, pentene, methylpentene, hexene, octene and decene), for example. Other monomers include ethylenically unsaturated monomers, C₄ to C₁₈ diolefins, conjugated or nonconjugated dienes, polyenes, vinyl monomers and cyclic olefins, for example. Non-limiting examples of other monomers may include norbornene, nobornadiene, isobutylene, isoprene, vinylbenzocyclobutane, sytrene, alkyl substituted styrene, ethylidene norbornene, dicyclopentadiene and cyclopentene, for example. The formed polymer may include homopolymers, copolymers or terpolymers, for example.

Examples of solution processes are described in U.S. Pat. No. 4,271,060, U.S. Pat. No. 5,001,205, U.S. Pat. No. 5,236,998 and U.S. Pat. No. 5,589,555, which are incorporated by reference herein.

One example of a gas phase polymerization process includes a continuous cycle system, wherein a cycling gas stream (otherwise known as a recycle stream or fluidizing medium) is heated in a reactor by heat of polymerization. The heat is removed from the cycling gas stream in another part of the cycle by a cooling system external to the reactor. The cycling gas stream containing one or more monomers may be continuously cycled through a fluidized bed in the presence of a catalyst under reactive conditions. The cycling gas stream is generally withdrawn from the fluidized bed and recycled back into the reactor. Simultaneously, polymer product may be withdrawn from the reactor and fresh monomer may be added to replace the polymerized monomer. The reactor pressure in a gas phase process may vary from about 100 psig to about 500 psig, or from about 200 psig to about 400 psig or from about 250 psig to about 350 psig, for example. The reactor temperature in a gas phase process may vary from about 30° C. to about 120° C., or from about 60° C. to about 115° C., or from about 70° C. to about 110° C. or from about 70° C. to about 95° C., for example. (See, for example, U.S. Pat. No. 4,543,399, U.S. Pat. No. 4,588,790, U.S. Pat. No. 5,028,670, U.S. Pat. No. 5,317,036, U.S. Pat. No. 5,352,749, U.S. Pat. No. 5,405,922, U.S. Pat. No. 5,436,304, U.S. Pat. No. 5,456,471, U.S. Pat. No. 5,462,999, U.S. Pat. No. 5,616,661, U.S. Pat. No. 5,627,242, U.S. Pat. No. 5,665,818, U.S. Pat. No. 5,677,375 and U.S. Pat. No. 5,668,228, which are fully incorporated by reference herein.)

Slurry phase processes generally include forming a suspension of solid, particulate polymer in a liquid polymerization medium, to which monomers and optionally hydrogen, along with catalyst, are added. The suspension (which may include diluents) may be intermittently or continuously removed from the reactor where the volatile components can be separated from the polymer and recycled, optionally after a distillation, to the reactor. The liquefied diluent employed in the polymerization medium may include a C₃ to C₇ alkane (e.g., hexane or isobutane), for example. The medium employed is generally liquid under the conditions of polymerization and relatively inert. A bulk phase process is similar to that of a slurry process. However, a process may be a bulk process, a slurry process or a bulk slurry process, for example.

In a specific embodiment, a slurry process or a bulk process may be carried out continuously in one or more loop reactors. The catalyst, as slurry or as a dry free flowing powder, may be injected regularly to the reactor loop, which can itself be filled with circulating slurry of growing polymer particles in a diluent, for example. Optionally, hydrogen may be added to the process, such as for molecular weight control of the resultant polymer. The loop reactor may be maintained at a pressure of from about 27 bar to about 45 bar and a temperature of from about 38° C. to about 121° C., for example. Reaction heat may be removed through the loop wall via any method known to one skilled in the art, such as via a double-jacketed pipe or heat exchanger, for example.

Alternatively, other types of polymerization processes may be used, such stirred reactors in series, parallel or combinations thereof, for example. Upon removal from the reactor, the polymer may be passed to a polymer recovery system for further processing, such as addition of additives and/or extrusion, for example.

Polymerization processes may further include the addition of a promoter to further boost activity. The addition of the promoter may be accomplished by any method known to one skilled in the art. For example, the promoter may be introduced to the reaction vessel separate from the activated catalyst. However, the promoter may contact the activated catalyst prior to entering the reaction vessel. Further, promoter may be introduced directly into the polymerization medium or may be diluted in a liquid hydrocarbon, such as isopentane, n-pentane, n-hexane or n-heptane, for example.

Conventional promoters may include chloroalkanes and metal chlorides, such as iron chloride. The chloralkanes may include methylene chloride, chloroform, carbon tetrachloride, trichloro-1,1,1 ethane or dichloro-1,2 ethane, for example.

Generally, the promoters have been employed in amounts effective to promote (e.g., increase) the polymerization activity of the supported Ziegler-Natta catalyst. For example, specific processes may include a molar equivalent of the promoter to the active metal site of the catalyst system of from about 1:1 to about 500:1 or from about 5:1 to about 200:1, for example.

However, the catalyst systems described herein have generally exhibited lower than desired activity when conventional promoters were utilized therewith.

However, embodiments of the invention utilize an alkyl chloride, such as 1-chlorobutane as a promoter. Unexpectedly, it has been discovered that utilizing 1-chlorobutane as the promoter results in increased catalyst activity in comparison to even other chloroalkanes. For example, the catalyst activity is at least 20%, or at least 25% or at least 30% greater than the catalyst activity absent the promoter. Further, the catalyst activity may be at least 5% or 10% greater than that experienced with non-inventive chloroalkanes, for example.

### Polymer Product

The polymers and blends thereof formed via the processes described herein may include, but are not limited to, linear low density polyethylene, elastomers, plastomers, high density polyethylenes, low density polyethylenes, medium density polyethylenes, polypropylene (e.g., syndiotactic, atactic and isotactic) and polypropylene copolymers, for example.

In one embodiment, the polymers include polyethylene.

The polyethylene exhibited approximately the same (e.g., within from about 1% to about 20%, or from about 2% to about 10%) molecular weight as polymers not including the inventive embodiments described herein at low levels of promoter. The low levels generally include from about 5 equivalents to about 25 equivalents or from about 8 equivalents to about 15 equivalents, for example.

A broadening of the polyethylene molecular weight was observed through a high molecular weight tail at higher levels of promoter. The higher levels generally include from about 50 equivalents to about 250 equivalents or from about 75 equivalents to about 125 equivalents, for example.

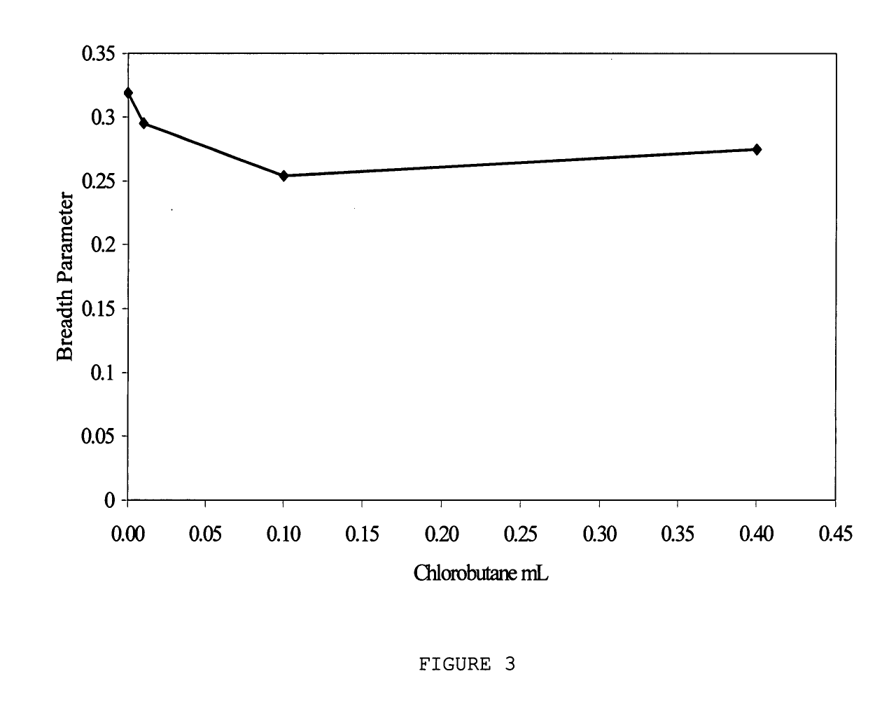

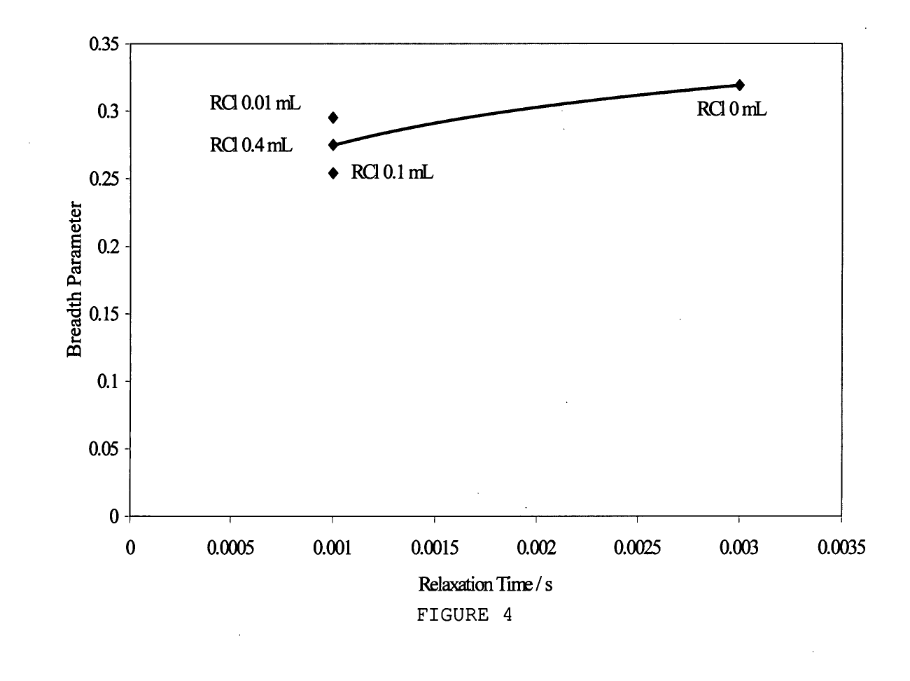

In addition, the polymers produced via the embodiments described herein exhibited enhanced shear thinning. See, FIGS. 3 and 4.

### Product Application

The polymers and blends thereof are useful in applications known to one skilled in the art, such as forming operations (e.g., film, sheet, pipe and fiber extrusion and co-extrusion as well as blow molding, injection molding and rotary molding). Films include blown or cast films formed by co-extrusion or by lamination useful as shrink film, cling film, stretch film, sealing films, oriented films, snack packaging, heavy duty bags, grocery sacks, baked and frozen food packaging, medical packaging, industrial liners, and membranes, for example, in food-contact and non-food contact application. Fibers include melt spinning, solution spinning and melt blown fiber operations for use in woven or non-woven form to make filters, diaper fabrics, medical garments and geotextiles, for example. Extruded articles include medical tubing, wire and cable coatings, geomembranes and pond liners, for example. Molded articles include single and multi-layered constructions in the form of bottles, tanks, large hollow articles, rigid food containers and toys, for example.

In particular, the polymers described herein are useful in applications requiring enhanced shear thinning or selective high molecular weight broadening/tailing. For example, the polymers are particularly useful in films, such as blown films and barrier films. In particular, polyethylene-based films are particularly useful in food packaging applications as a result of their shelf life, product protection, product display and packaging/shipping costs. The characteristic of the packaged food product generally determines the optimal barrier performance for the packaging materials. Optimum barrier properties for some foods require high-barrier packaging materials while others require low-barrier materials to maximize shelf life.

The barrier properties of a polymer generally increase with a narrowing in the molecular weight distribution of the polymer, whereas broader molecular weight distribution polymer may be more greatly affected by processing conditions. Further, narrow molecular weight distribution polymers generally have relatively constant barrier properties per unit thickness, while permeation rates form broad molecular weight distribution polymers may be significantly higher for thin films.

However, the selective broadening as evidenced by a high molecular weight tail) of the polymers formed by the process described herein generally result in polymers having the benefits of such broadening, while retaining barrier properties.

### EXAMPLES

In the following examples, samples of polyethylene were prepared with varying amounts and types of promoters.

As used in the examples, “BEM” refers to 20.2 wt. % solution of butyl ethyl magnesium (0.12 wt. % Al).

As used in the examples, “EtOH” refers to 2-ethylhexanol.

As used in the examples, “TEAl” refers to triethyl aluminum.

As used in the examples, “silica P-10” refers to silica that was obtained from Fuji Sylisia Chemical LTD (grade: Cariact P-10, 20 μm), such silica having a surface area of 281 m²/g, a pore volume of 1.41 mL/g, an average particle size of 20.5 μm and a pH of 6.3.

As used in the examples, “1-chlorobutane” refers to anhydrous 1-chlorobutane (99.5% purity) obtained from Aldrich Chemical.

Catalyst Preparation: The preparation of the catalyst used in all polymerizations was achieved as described below. A solution of EtOH (50 mmol) in hexane (50 mL) was added dropwise to a rapidly stirred (250 rpm) hexane solution of BEM (25 mmol diluted to 100 mL total volume) at room temperature over 30 minutes and the reaction mixture was then stirred at room temperature for another hour.

Then, a solution of ClTi(OⁱPr)₃ (12.5 mL of a 2.0 M solution in hexane, 25 mmol) was added to the mixture at room temperature over 30 minutes. A clear, solid free solution (reaction mixture “A”) was obtained. The solution was then stirred at room temperature for another hour.

P-10 silica (5.0 g) was next added to the mixture.

The preparation then included the dropwise addition of TiCl₄ (50 mmol diluted to 50 mL total in hexane) to the reaction mixture “A” at room temperature over 20 minutes to form reaction mixture “B”. The reaction mixture “B” was then stirred at room temperature for another hour. Agitation was discontinued and the reaction mixture “B” was allowed to settle. The solution phase was then decanted and the solids were suspended in 200 mL of hexane.

After this, a solution of TiCl₄ (50 mmol diluted to 50 mL with hexane) was added dropwise to the reaction mixture “B” at room temperature over 20 minutes to form reaction mixture “C”. The reaction mixture “C” was then stirred at room temperature for another hour. Agitation was discontinued and the reaction mixture “C” was allowed to settle. The solution phase was decanted and the resultant solids were suspended in hexane and agitated. The above washing procedure was repeated twice (two times 200 mL of hexane) and the washed solids were then suspended in 150 mL of hexane.

A solution of TEA (25 wt % in hexane, 1.8 mmol) was next added to the reaction mixture “C” at room temperature over 25 minutes to form the catalyst composition. The catalyst composition was then stirred at room temperature for another hour. Agitation was discontinued and the solid was allowed to settle. The solution was decanted and the resultant solid was dried in vacuo to provide the final catalyst employed in the examples.

Polymerizations: The catalyst was screened for activity in the polymerization with ethylene monomer to form polyethylene. Polymerizations were performed in a 4 L autoclave engineer system fitted with four mixing baffles and two opposed pitch propellers. Salient polymerization conditions are outlined below.

### Polymerization Conditions

| Pressure | 306 psig |
|---|---|
| Temperature, ° C. | 80 |
| Initial Ethylene Charge, L | 7.5 |
| Initial H₂ Charge, L | 50 |
| Consumption Target, L | 300 |
| Polymerization Diluent | isobutane |
| Catalyst Charge, mg | 100 mg |
| [TEAl], mmol/L | 0.50 |
| [Chlorobutane], mmol/L | 1.05, 2.1, 4.2, 8.2, 19.8 |
| C₄H₉Cl/Ti, molar ratio | 12.5, 25, 50, 100, 240 |

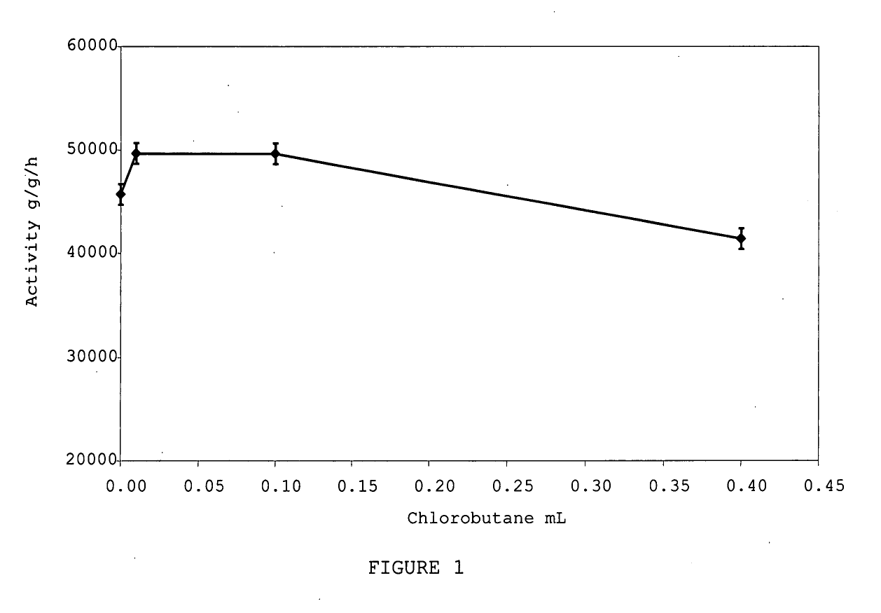

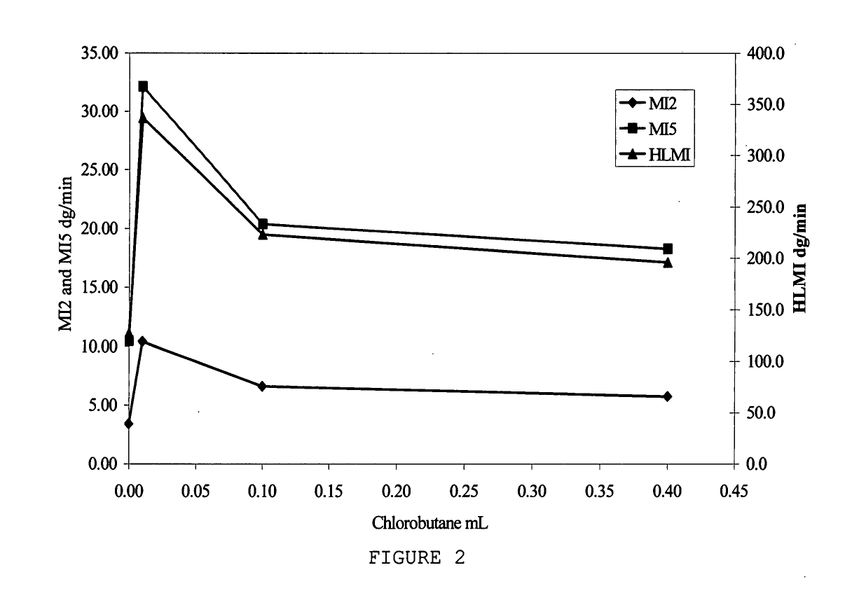

For these experiments, 1-chlorobutane and the catalyst were collected in separate bombs and introduced to the reaction vessel simultaneously with an isobutene flush. The results of such polymerizations follow in Table 1 and FIGS. 1, 2, 3 and 4.

TABLE 1

| Run | CB (mmol) | CB/Ti equiv | Mn | Mz |
|---|---|---|---|---|
| 6 | 0 | 0 | 16,001 | 1,096,759 |
| 1 | 1.1 | 12.5 | 15,877 | 1,068,176 |
| 2 | 2.1 | 25 | 14,810 | 716,942 |
| 3 | 4.2 | 50 | 14,758 | 681,716 |
| 4 | 8.2 | 100 | 16,029 | 1,184,465 |
| 5 | 19.8 | 240 | NR | NR |

Poly. Cond.: 306 psi, 80° C., 7.5 STL C₂, 50 STL H₂, 0.15 H₂/C₂, cat = 100 mg, diluent = isobutene, CB = 1-chlorobutane,
NR means not recorded

As demonstrated above and in the figures, embodiments of the invention result in increased catalyst activity (see, FIG. 1) and enhanced shear thinning properties (see, FIGS. 3 and 4), along with molecular weight control.

While the foregoing is directed to embodiments of the present invention, other and further embodiments of the invention may be devised without departing from the basic scope thereof and the scope thereof is determined by the claims that follow.

What is claimed is:

1. A polymerization process comprising:
providing a catalyst system formed from a process comprising:
contacting a magnesium dialkoxide compound with a first agent to form a first compound;
contacting the first compound with a plurality of halogenating/titanating agents to form a reaction product;
contacting the reaction product with an activating agent to form the catalyst system;
introducing the catalyst system to a reaction zone;
introducing 1-chlorobutane to the reaction zone;
introducing an olefin monomer to the reaction zone;
contacting the olefin monomer with the catalyst system in the presence of the 1-chlorobutane to form a polyolefin; and
withdrawing the polyolefin from the reaction zone.

2. The process of claim 1, wherein the polyolefin comprises polyethylene.

3. The process of claim 1, wherein the magnesium dialkoxide is formed by contacting an alkyl magnesium compound with an alcohol.

4. The process of claim 3, wherein the magnesium dialkoxide comprises butyl ethyl magnesium.

5. The process of claim 3, wherein the alcohol comprises 2-ethyl hexanol.

6. The process of claim 1, wherein the first agent is represented by the formula ClA(OR⁴)_{y}; wherein Cl is chlorine, A is selected from titanium, silicon, aluminum, carbon, tin and germanium, R⁴ is selected from C₁ to C₁₀ alkyls, x is 0 or 1 and y is the valence of A minus 1.

7. The process of claim 1, wherein the catalyst system is formed from a process further comprising contacting the first compound with a second agent represented by the formula TiCl₄/Ti(OR⁵)₄, wherein R⁵ is selected from C₂ to C₁₀ alkyl groups.

8. The process of claim 1, wherein at least one of the plurality of halogenating/titanating agents comprises TiCl₄.

9. The process of claim 1, wherein the activating agent comprises an organoaluminum compound.

10. The process of claim 9, wherein the organoaluminum compound comprises triethyl aluminum.

11. The process of claim 1, wherein the 1-chlorobutane is added to the reaction zone in an equivalent of from about 1:1 to about 500:1.

12. The process of claim 1, wherein the 1-chlorobutane is added to the reaction zone in an equivalent of from about 5:1 to about 75:1.

13. The process of claim 1, wherein the catalyst system exhibited an activity that is at least 20% higher than the activity of an identical process absent the 1-chlorobutane.

14. A polymer produced from a process comprising:
providing a catalyst system formed from a process comprising:
contacting a magnesium dialkoxide compound with a first agent to form a first compound;
contacting the first compound with a plurality of halogenating/titanating agents to form a reaction product;
contacting the reaction product with an activating agent to form the catalyst system;
introducing the catalyst system to a reaction zone;
introducing 1-chlorobutane to the reaction zone;
introducing an olefin monomer to the reaction zone;
contacting the olefin monomer with the catalyst system in the presence of the 1-chlorobutane to form an olefin polymer; and
withdrawing the olefin polymer from the reaction zone.

15. The polymer of claim 14, wherein the olefin polymer comprises polyethylene.

16. The polymer of claim 14, wherein an equivalent of 1-chlorobutane to catalyst system is from about 5:1 to about 20:1.

17. The polymer of claim 16, wherein the polymer comprises a molecular weight that is within 10% of the molecular weight of a polymer produced from an identical process absent the 1-chlorobutane.

18. The polymer of claim 14, wherein an equivalent of 1-chlorobutane to catalyst system is from about 50:1 to about 125:1.

19. The polymer of claim 18, wherein the polymer exhibits a broader molecular weight distribution than a polymer produced from an identical process absent the 1-chlorobutane.

20. A polymerization process comprising:
providing a catalyst system formed from a process comprising:
contacting butyl ethyl magnesium with a first agent represented by the formula ClA(OR⁴)_{y} to form a first compound, wherein A is selected from titanium, silicon, aluminum, carbon, tin and germanium, R⁴ is selected from C₁ to C₁₀ alkyls, x is 0 or 1 and y is the valence of A minus 1;
contacting the first compound with a second agent represented by the formula TiC₄/Ti(OR⁵)₄, wherein R⁵ is selected from C₂ to C₁₀ alkyl groups;
contacting the first compound with a plurality of halogenating/titanating agents to form a reaction product, wherein at least one of the plurality of halogenating/titanating agents comprises TiCl₄; and
contacting the reaction product with an activating agent comprising an organoaluminum compound to form the catalyst system;
introducing the catalyst system to a reaction zone;
introducing 1-chlorobutane to the reaction zone;
introducing an ethylene monomer to the reaction zone;
contacting the ethylene monomer with the catalyst system in the presence of the 1-chlorobutane to form polyethylene; and
withdrawing the polyethylene from the reaction zone.
